(19) United States
(12) Patent Application Publication
(10) Pub. No.: US 2013/0037602 A1
(43) Pub. Date: Feb. 14, 2013

(54) FRICTION STIR WELDING METHOD OF METALLIC HOUSING

(71) Applicants: WEI-TING WANG, Tu-Cheng (TW); CHUN-LANG LEE, Tu-Cheng (TW); YU-WEN CHIU, Tu-Cheng (TW)

(72) Inventors: WEI-TING WANG, Tu-Cheng (TW); CHUN-LANG LEE, Tu-Cheng (TW); YU-WEN CHIU, Tu-Cheng (TW)

(73) Assignee: HON HAI PRECISION INDUSTRY CO., LTD., Tu-Cheng (TW)

(21) Appl. No.: 13/313,180

(22) Filed: Dec. 7, 2011

(30) Foreign Application Priority Data
Aug. 10, 2011 (CN) 201110228336.X

(51) Int. Cl. B23K 20/12; B23K 20/24

(52) U.S. Cl. 228/114

(57) ABSTRACT

A friction stir welding method of manufacturing a metallic housing including electronic device housing is described as follow. A first workpiece and a second workpiece made of metal are provided. The first workpiece is attached to the second workpiece. A joining tool is provided, which includes a shaft shoulder and a stir pin extending from a friction surface of the shaft shoulder. A diameter of the shaft shoulder is in a range from about 8 mm to about 15 mm. The first workpiece and the second workpiece are stirred and rubbed by rotating the joining tool, thereby forming the electronic device housing. The electronic device housing is anodized.

### BACKGROUND

1. Technical Field

The present disclosure generally relates to friction stir welding methods, and particularly, to a friction stir welding method of a metallic housing.

2. Description of the Related Art

Friction stir welding is widely used to join aluminum alloy because it is simple to perform.

A metal structure of the stirred product can be uneven in consistency, since the material of the stirred portion of the product plastically flows in the friction stir welding process. After treatment, the different areas, specifically the stirred and unstirred portions of the product, may exhibit different textures. The joining portion of between the workpieces provides an unfavorable appearance. Despite product annealing, the difference in appearance of the joined portion persists. Therefore, this cannot satisfy a product with the stirred surface presented as an outer surface. Achievement of a favorable appearance in products obtained by friction stir welding remains a challenge.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an electronic device housing made by an embodiment of a friction stir welding method.

FIG. 2 is a flowchart of the friction stir welding method of the embodiment.

FIG. 3 is an isometric view of a first workpiece and a second workpiece provided for forming the electronic device housing of FIG. 1 by the friction stir welding method.

FIG. 4 is an isometric view of the first workpiece and the second workpiece being welded to each other by the friction stir welding method.

### DETAILED DESCRIPTION

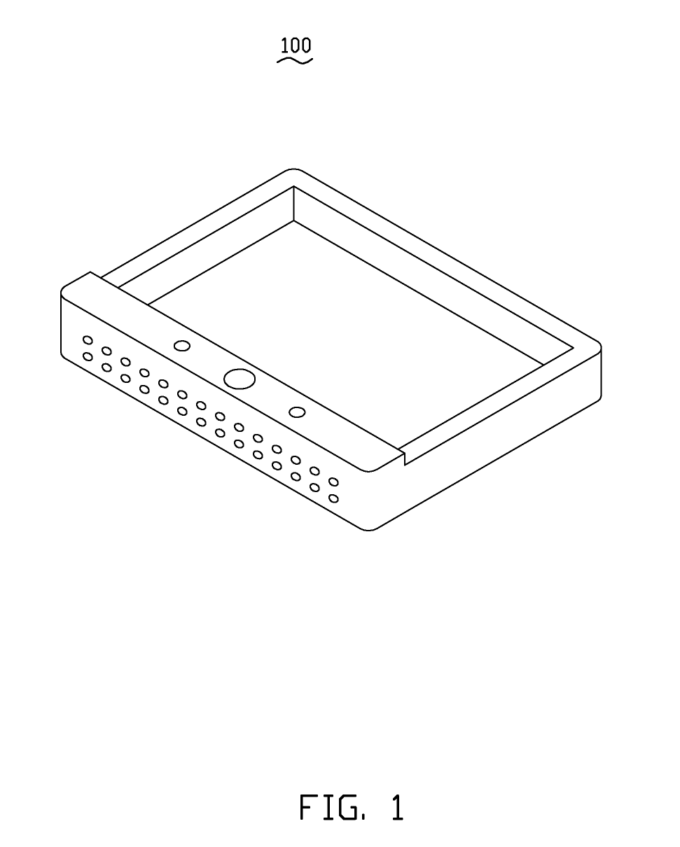

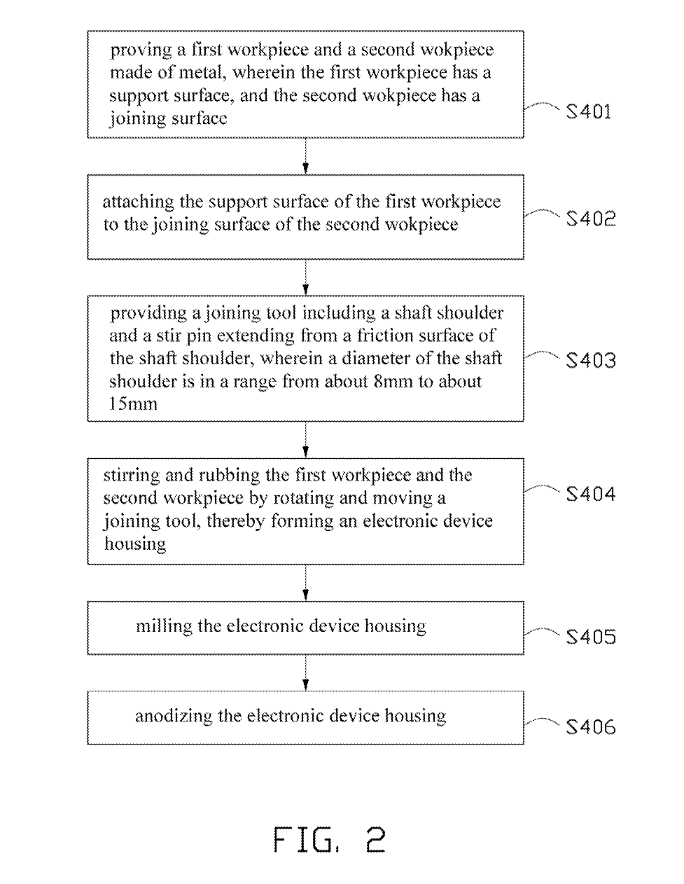

Referring to FIGS. 1 and 2, an embodiment of a friction stir welding method for manufacturing an electronic device housing 100 is described as follow. The electronic device housing 100 may be a display housing, a tablet PC housing, or a mobile phone housing. In the illustrated embodiment, the electronic device housing 100 is a display housing.

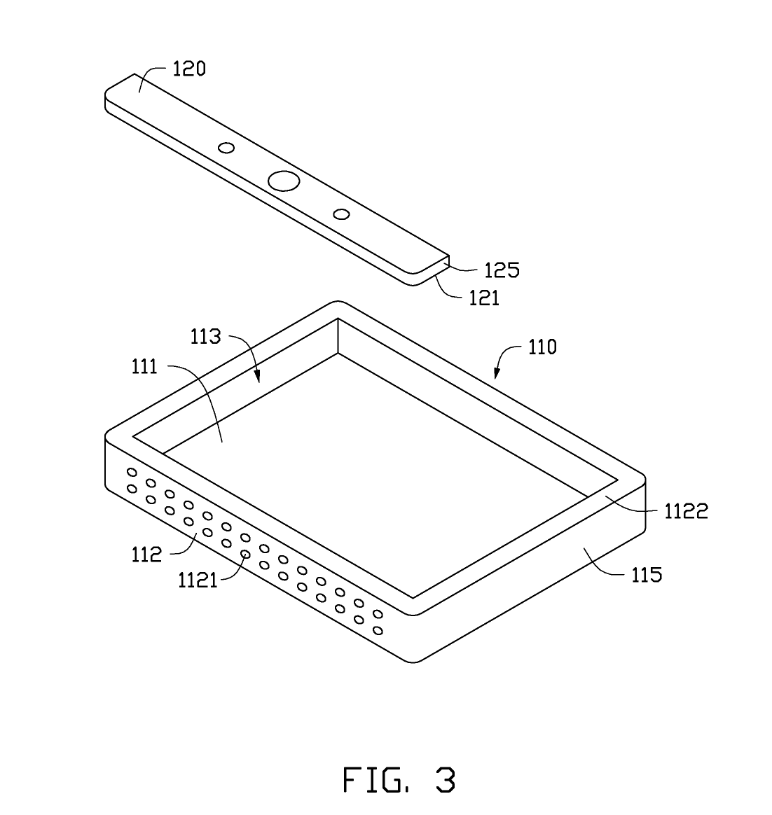

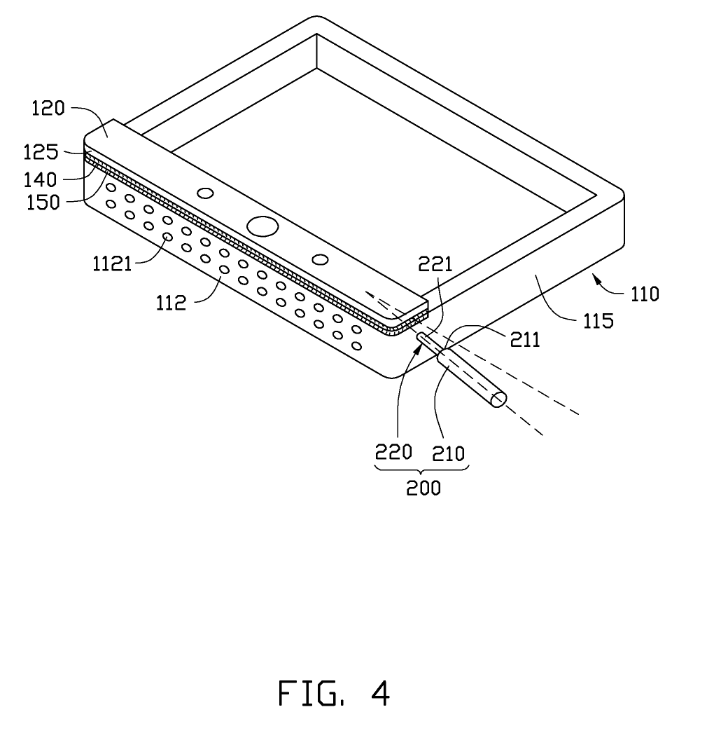

Referring also to FIGS. 3 and 4, in step S401, a first workpiece 110 and a second piece 120 are provided. The first workpiece 110 and the second piece 120 are made of metal. The first workpiece 110 includes a support surface 1122 and a side surface 115, and the second workpiece 120 includes a joining surface 121 and a side surface 125. In the illustrated embodiment, the first workpiece 110 and the second workpiece 120 are made of aluminum (Al).

The first workpiece 110 includes a bottom plate 111 and a plurality of side plates 112 extending from an edge of the bottom plate 111, such that the bottom plate 111 and the side plates 112 cooperatively define a receiving groove 113. In the illustrated embodiment, the bottom plate 111 and the side plates 112 are integrally formed. The first workpiece 110 includes four side plates 112, and one of the side plates 112 defines a plurality of heat dissipating holes 1121. The support surface 1122 is formed on a top of the side plates 112. The second workpiece 120 is a substantially rectangular plate.

In the illustrated embodiment, a thickness of the first workpiece 110 or the second workpiece 120 is about 2.5 mm, and the first workpiece 110 and the second workpiece 120 are made of Al alloy 5052. It should be understood that, the first workpiece 110 and the second workpiece 120 can also be made of Al alloy 2024, 5083, 6061, 7050, 7075.

In step S402, the joining surface 121 of the second workpiece 120 is attached to the support surface 1122 of the first workpiece 110, thereby defining a joint line 140. In the illustrate embodiment, the second workpiece 120 is positioned on a side of the first workpiece 110, with the side surface 125 being coplanar with the side surface 115. A predetermined welding area 150 defined by the first workpiece 110 and the second workpiece 120 extends along the joint line 140.

In step S403, a joining tool 200 is provided. The joining tool 200 includes a shaft shoulder 210 and a stir pin 220 extending from a friction surface 211 of the shaft shoulder 210. The stir pin 220 is aligned with the shaft shoulder 210 at the central axis in an imaginary straight line. A diameter of the stir pin 220 is smaller than that of the shaft shoulder 210. The diameter of the shaft shoulder 210 may be in a range from about 8 mm to about 15 mm, and the diameter of the stir pin 220 may be in a range from about 1 mm to about 4 mm. In the illustrated embodiment, the diameter of the shaft shoulder 210 is about 8 mm, and the diameter of the stir pin 220 is about 2 mm.

In step S404, the first workpiece 110 and the second workpiece 120 are stirred and rubbed by rotating the joining tool 200, thereby forming the electronic device housing 100. In the friction stir welding process, the stir pin 220 is vertically inserted between the first workpiece 110 and the second workpiece 120, until the friction surface 211 of the shaft shoulder 210 extends slightly into the predetermined welding area 150. The joining tool 200 rotates at a relatively high speed, and is inserted between the first workpiece 110 and the second workpiece 120 at a relatively low speed. For example, the joining tool 200 may rotate at a speed from about 2000 r/min to 5000 r/min, and is inserted between the first workpiece 110 and the second workpiece 120 at a speed from about 50 mm/min to about 200 mm/min. In the illustrated embodiment, the stir pin 220 rotates at a speed of about 3000 r/min, and is inserted between the first workpiece 110 and the second workpiece 120 at a speed of about 100 mm/min.

The joining tool 200 rotates along the axis thereof relative to the first workpiece 110 and the second workpiece 120 and moves along the joint line 140, therefore, a cylindrical surface 221 of the stir pin 220 rubs the joining surface 121 and the support surface 1122, and the friction surface 211 of the shaft shoulder 210 rubs the predetermined welding area 150. Thus, the joining tool 200 produces a local region of highly plasticized material such that the first workpiece 110 and the second workpiece 120 diffuse among each other. As such, the first workpiece 110 and the second workpiece 120 are thereby joined. The joining tool 200 may move along the joint line 140 at a speed from about 600 mm/min to about 1000 mm/min, and in the present embodiment, the joining tool 200 moves along the joint line 140 at a speed from about 700 mm/min.

In order to further improve the joint strength of the first workpiece 110 and the second workpiece 120, the axis of the joining tool 200 may be slanted to the joint line 140. Fox example, the axis of the joining tool 200 is slanted to form a straight line substantially perpendicular to the joint line 140 having an angle in a range from about 5 degrees to about 6 degree, as shown in FIG. 4.

When the joining tool 200 moves to an end of the joint line 140, the stir pin 220 stops moving, and keep rotating for two seconds, after that, the joining tool 200 is pulled out of the predetermined welding area 150, and the predetermined welding area 150 is cooled. The predetermined welding area 150 may be cooled by water or wind.

In step S405, the predetermined welding area 150 is milled by a cutter (not shown). In step S406, the electronic device housing 100 is anodized to achieve an attractive appearance.

It should be appreciated that, if the electronic device housing 100 does not require a high degree of flatness, the fourth step S404 can be omitted. The first workpiece 110 and the second workpiece 120 may be made of Al alloy 2024, 5083, 6061, 7050, 7075, thereby reducing the effect of chromatic aberration of the predetermined welding area 150. In the friction stir welding process, the rotating speed of the stir pin 220 can be adjusted from about 2000 r/min to about 5000 r/min, and the inserting speed of the stir pin 220 can be adjusted from about 50 mm/min to about 200 mm/min, therefore, the effect of chromatic aberration of the predetermined welding area 150 is further reduced. In addition, the electronic device housing 100 may undergo other machining steps before step S404, such as sandblasting.

Because the first workpiece 110 and the second workpiece 120 are anodized to form the electronic device housing 100, thus the predetermined welding area 150 substantially has the same color as the adjacent parts of the predetermined welding area 150. As a result, the electronic device housing 100 can have an excellent appearance. Furthermore, the rotating speed of the joining tool 200 is set from about 2000 r/min to about 5000 r/min, the inserting speed of the stir pin 220 is set from about 50 mm/min to about 200 mm/min, and the moving speed of the joining tool 200 along the joint line 140 is set from about 600 mm/min to about 1000 mm/min, thereby making the electronic device housing 100 to have an excellent appearance.

In addition, the friction stir welding method of the present embodiment may be also used for manufacturing other metallic housing apart from the electronic device housing 100.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

1. A friction stir welding method for manufacturing a metallic housing, comprising:
providing a first workpiece and a second workpiece made of metal, wherein the first workpiece has a support surface, and the second workpiece has a joining surface;
attaching the support surface of the first workpiece to the joining surface of the second workpiece, a joint line being formed between the first workpiece and the second workpiece;
providing a joining tool comprising a shaft shoulder and a stir pin extending from a friction surface of the shaft shoulder, wherein a diameter of the shaft shoulder is in a range from about 8 mm to about 15 mm;
inserting and rotating the stir pin between the first workpiece and the second workpiece until the friction surface of the shaft shoulder abutting against the first workpiece and the second workpiece;
rotating and moving the joining tool along the joint line to rub and stir at least one of the first workpiece and the second workpiece, until at least part of the first workpiece and the second workpiece are plasticized and joined together to form the metallic housing, then the stir pin stopping the linear movement of the joining tool along the joint line, and keep rotating for about two seconds, and finally pulling out the joining tool; and
anodizing the metallic housing.

2. The friction stir welding method of claim 1, wherein a diameter of the stir pin is in a range from about 1 mm to about 4 mm.

3. (canceled)

4. The friction stir welding method of claim 1, wherein a rotating speed of the joining tool is set from about 2000 r/min to about 5000 r/min.

5. The friction stir welding method of claim 4, wherein an inserting speed of the stir pin is set from about 50 mm/min to about 200 mm/min.

6. The friction stir welding method of claim 4, wherein a moving speed of the joining tool along the joint line is set from about 600 mm/min to about 1000 mm/min.

7. (canceled)

8. The friction stir welding method of claim 1, wherein the first workpiece and the second workpiece are made of Al alloy selected from a group consisting of Al alloy 5052, 2024, 5083, 6061, 7050, and 7075.

9. The friction stir welding method of claim 1, wherein the metallic housing is milled before anodizing the metallic housing.

10. The friction stir welding method of claim 1, wherein the first workpiece comprises a bottom plate and a plurality of side plates extending from an edge of the bottom plate, such that the bottom plate and the side plates cooperatively define a receiving groove.

11. The friction stir welding method of claim 10, wherein one of the plurality of side plates defines a plurality of heat dissipating holes.

12. The friction stir welding method of claim 10, wherein the second workpiece is a substantially rectangular plate, and attached to a side of the first workpiece.

13. A friction stir welding method of manufacturing an electronic device housing, comprising:
providing a first workpiece and a second workpiece made of metal, wherein the first workpiece has a support surface, and the second workpiece has a joining surface;
attaching the support surface of the first workpiece to the joining surface of the second workpiece, a joint line being formed between the first workpiece and the second workpiece;
providing a joining tool comprising a shaft shoulder and a stir pin extending from a friction surface of the shaft shoulder;
inserting and rotating the stir pin between the first workpiece and the second workpiece until the friction surface of the shaft shoulder abutting against the first workpiece and the second workpiece, wherein a rotating speed of the joining tool is set from about 2000 r/min to about 5000 r/min, and an inserting speed of the stir pin is set from about 50 mm/min to about 200 mm/min;
rotating and moving the joining tool along the joint line to rub and stir at least one of the first workpiece and the second workpiece, until at least part of the first workpiece and the second workpiece are plasticized and joined together, then the stir pin stopping the linear movement of the joining tool along the joint line, and keep rotating for about two seconds, and finally pulling out the joining tool; and
anodizing the first workpiece and the second workpiece to form the electronic device housing.

14. (canceled)

15. The friction stir welding method of claim 13, wherein a moving speed of the joining tool along the joint line is set from about 600 mm/min to about 1000 mm/min.

16. (canceled)

17. The friction stir welding method of claim 13, wherein the first workpiece and the second workpiece are made of Al alloy selected from a group consisting of Al alloy 5052, 2024, 5083, 6061, 7050, 7075.

18. The friction stir welding method of claim 13, wherein the electronic device housing is milled before anodizing the electronic device housing.

19. The friction stir welding method of claim 13, wherein the first workpiece comprises a bottom plate and a plurality of side plates extending from an edge of the bottom plate, such that the bottom plate and the side plates cooperatively define a receiving groove.

20. The friction stir welding method of claim 19, wherein one of the plurality of side plates defines a plurality of heat dissipating holes.
